(19) United States
(12) Patent Application Publication
(10) Pub. No.: US 2024/0289904 A1
(43) Pub. Date: Aug. 29, 2024

(54) SYSTEM AND METHOD FOR TENANT DEBT SETTLEMENT SYSTEM

(71) Applicant: COLLEEN TECHNOLOGIES LTD, Petach Tikva (IL)

(72) Inventors: Ethan BAHIR, Petach Tikva (IL); Jonathan LASERSON, Ramat Gan (IL); Nir OSIROFF, Raanana (IL)

(73) Assignee: COLLEEN TECHNOLOGIES LTD, Petach Tikva (IL)

(21) Appl. No.: 18/588,514

(22) Filed: Feb. 27, 2024

Related U.S. Application Data
(60) Provisional application No. 63/487,267, filed on Feb. 28, 2023.

(51) Int. Cl. G06Q 50/163

(52) U.S. Cl. CPC G06Q 50/163

(57) ABSTRACT

Automatic landlord systems, methods and computer program products for settling debtors' debts following termination or end of a property contract are provided. The systems, methods and computer products interface with the landlord to update a debtor's database, collect in a debtor database various data and conditions relating to the debt of each debtor, and negotiate the debt payment by automatically issuing settlement proposals based on the data, receiving debtors' responses and analyzing them to determine agreements and refusals, the former handled by issuing a release document and the latter by further negotiations or by 3^{rd} party collection. The negotiation may be carried out by generative artificial intelligence (GenAI) algorithms implementing multiple agents to represent multiple sides in the process (communication analysis, market analysis, collection, owners, debtors and negotiations strategies) and thereby optimize the debt collection process.

### CROSS REFERENCE TO RELATED APPLICATIONS

This application claims priority from U.S. Provisional Application No. 63/487,267 filed on Feb. 28, 2023, which is incorporated herein by reference in its entirety.

### BACKGROUND OF THE INVENTION

### 1. Technical Field

The invention relates, in general, to the field of real estate rental management. More specifically, the invention relates to an automatic system enabling a property manager and a tenant to settle a tenant's debt upon termination or the end of the rental contract. Additionally, the present invention relates to the field of communication systems, and more particularly, to AI (artificial intelligence)-based communication systems.

### 2. Discussion of Related Art

In the US, over 40% of the population live in rental Homes/units/houses (hence “Apartments”). The NMHC (National Multifamily Housing Council) collected rent payment data from over 12 million apartments over three years 2019-2021. The NMHC study shows that around 20 percent of tenants do not pay their rent on time, and a quarter of them (about 5 percent of all renters) do not pay at all. Most tenants from this 5% portion are eventually forced to leave their rental home or go through an eviction process.

It is a huge loss for owners, property managers, or operators (hence “Landlords”). Considering an average rent cost of 1,500 USD and management of 1,000 apartments by a landlord, the loss amounts to almost 1 million USD per year for every 1,000 apartments.

Most of these past tenants with debt (hence “Debtor”) will be forced to vacate their rental apartments, and some will go through an eviction process. Eviction is a very common process; each year, there are millions of evictions in the US alone. Moreover, studies over the last ten years show that around 40% of renters are not renewing their leases. Many renters leave their rentals or break their leases without proper notice. Some will move out, leaving damages. In many cases, the past tenant will leave delinquent rent and unpaid expenses.

Lease agreements include a “Security deposit.” It is usually a one-month rent. This amount is paid by the tenant in advance (when signing the rent agreement) and kept by the landlord as security funds to cover any debt or expenses related to the lease. Unfortunately, the security deposit does not cover the expenses in many cases.

The Landlords of these rental apartments try to collect the debt. Once the attempts are unsuccessful, they generally send these debt cases to a 3^{rd} party debt collection agency. Each month in the US, debt collection agencies receive debt cases valued at over 3 billion dollars from Landlords. These 3^{rd} party collection agencies enforce legal actions on behalf of the landlords to collect the debt.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides an automatic landlord system for settling past tenants' debts following the termination or end of a property contract, comprising, at the landlord side: a landlord interface for updating a debtor's database; a debtor database comprising, for each debtor, the debtor's data, the debt amount, and optionally personal's debtor's conditions set by the landlord for negotiating the debt; and a negotiator for (i) automatically issuing one or more settlement proposal communications with each debtor based on communication contents, optionally debtor's proposal, and data acquired from said debtor database, and communicating the same to the debtor; (ii) receiving a response from the debtor to each communication, analyzing the same to determine either the debtor's agreement to the proposal and execution of a respective payment or a debtor's response proposal; and (iii) upon determination of a debtor's agreement and fulfilling a proposal's payment, automatically issuing a “release document”, and sending the same to the debtor.

In some embodiments of the invention, the debtor's data includes the debtor's personal data, the type of communication preference, and debtor's communication address, and in addition, one or more of: the time since the debtor moved out; the time since a last interaction with the debtor about the debt; the debtor's credit score; the debtor's payment history at the property; the negotiation flexibility of the landlord; the cost of a debt collection action; the probability of succeeding in a debt collection action; and the previous text conversations made with the debtor. In some embodiments, the debtor's communication is selectable from email, short messaging, or calls. In some embodiments, the “release document” includes an irrevocable landlord's obligation that the debtor has fully settled his debt and will not face any further legal action, and an example of a “release document” may be attached to a communication with the debtor before the debt settlement.

One aspect of the present invention provides a computer-implemented automatic landlord method of settling debtors' debts following termination or end of a property contract, the method comprising: (i) interfacing with the landlord to update a debtor's database, (ii) collecting in a debtor database, for each debtor, the debtor's data, the debt amount, and optionally personal's debtor's conditions set by the landlord for negotiating the debt, and negotiating the debt payment by: automatically issuing one or more settlement proposal communications with each debtor based on selectable predefined communication contents, predefined rules, optionally debtor's proposal, and data acquired from said debtor database, and communicating the same to the debtor, receiving a response from the debtor to each communication, analyzing the received response to determine either the debtor's agreement to the proposal and execution of a respective payment or a debtor's response proposal, upon determination of a debtor's agreement and fulfilling a proposal's payment, automatically issuing a release document, and sending the release document to the debtor.

In some embodiments, the computer-implemented method may further comprise implementing the corresponding GenAI modules as separate agents in the multi-agent architecture: (i) to represent the negotiator to manage the interactions with the debtors and to interact with the other GenAI modules, (ii) to analyze past resident's responses and actions to evaluate the past resident's sentiment, willingness to settle, and negotiation strategy, (iii) to represent a 3rd party collection service with corresponding 3rd party performance estimations and to inform the negotiator GenAI module what would be the likelihood and amount of a settled debt once sold off to a 3rd party, (iv) to represent wishes of the property owner to recover as much debt as possible while avoiding bad publicity, costly and lengthy legal recourse and management of 3rd party debts, and (v) to provide macro and micro market analysis by exploring a current economic situation, a local rent and debt economic metrics, a current state of debt payment, and a current interest and inflation conditions, wherein the analyst GenAI module further informs the other GenAI modules of a reasonable debt % to be expected as well as a reasonable payment plan.

One aspect of the present invention provides a computer program product for settling debtors' debts automatic to a landlord system following termination or end of a property contract, the computer program product comprising a non-transitory computer readable storage medium having computer readable program embodied therewith, the computer readable program comprising: computer readable program configured to interface with the landlord to update a debtor's database, computer readable program configured to collect in a debtor database, for each debtor, the debtor's data, the debt amount, and optionally personal's debtor's conditions set by the landlord for negotiating the debt, and computer readable program configured to negotiate the debt payment and comprising: computer readable program configured to automatically issue one or more settlement proposal communications with each debtor based on selectable predefined communication contents, predefined rules, optionally debtor's proposal, and data acquired from said debtor database, and communicating the same to the debtor, computer readable program configured to receive a response from the debtor to each communication, computer readable program configured to analyze the received response to determine either the debtor's agreement to the proposal and execution of a respective payment or a debtor's response proposal, computer readable program configured to, upon determination of a debtor's agreement and fulfilling a proposal's payment, automatically issue a release document, and computer readable program configured to send the release document to the debtor.

In some embodiments, the computer readable program further comprises computer readable program configured to implement the corresponding GenAI modules as separate agents in the multi-agent architecture, e.g., with the computer readable program further comprising: (i) computer readable program configured to represent the negotiator to manage the interactions with the debtors and to interact with the other GenAI modules, (ii) computer readable program configured to analyze past resident's responses and actions to evaluate the past resident's sentiment, willingness to settle, and negotiation strategy, (iii) computer readable program configured to represent a 3rd party collection service with corresponding 3rd party performance estimations and to inform the negotiator GenAI module what would be the likelihood and amount of a settled debt once sold off to a 3rd party, (iv) computer readable program configured to represent wishes of the property owner to recover as much debt as possible while avoiding bad publicity, costly and lengthy legal recourse and management of 3rd party debts, and (v) computer readable program configured to provide macro and micro market analysis by exploring a current economic situation, a local rent and debt economic metrics, a current state of debt payment, and a current interest and inflation conditions, wherein the analyst GenAI module further informs the other GenAI modules of a reasonable debt % to be expected as well as a reasonable payment plan.

These, additional, and/or other aspects and/or advantages of the present invention are set forth in the detailed description which follows, possibly inferable from the detailed description, and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIG. 1 is a high-level schematic block diagram of a system 100 for settling the debtor's debt in a property management setting, according to some embodiments of the invention.

FIG. 2 is a high-level schematic flowchart of a method which may be implemented by the disclosed system—for settling the debtor's debt in a property management setting, according to some embodiments of the invention.

FIG. 3 is a high-level schematic illustration of a generative AI negotiator model designed to optimize negotiations with past residents for debt resolution, which may be implemented as part of the negotiator module, according to some embodiments of the invention.

FIG. 4 is a high-level block diagram of exemplary controllers, which may be used with embodiments of the present invention.

FIG. 5 is a high-level schematic flowchart of a computerized method for settling the debtor's debt in a property management setting, according to some embodiments of the invention.

FIG. 6 provides experimental results indicating the long-term improvement achieved by disclosed systems and methods in collecting the debt, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing”, “deriving” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Some embodiments of the present invention provide efficient and economical methods and mechanisms for improved communication, enhanced by AI, and thereby provide improvements to the technological field of AI-based communication systems. Automatic landlord systems, methods and computer program products for settling debtors' debts following termination or end of a property contract are provided. The systems, methods and computer products interface with the landlord to update a debtor's database, collect in a debtor database various data and conditions relating to the debt of each debtor, and negotiate the debt payment by automatically issuing settlement proposals based on the data, receiving debtors' responses and analyzing them to determine agreements and refusals, the former handled by issuing a release document and the latter by further negotiations or by 3^{rd} party collection. The negotiation may be carried out by generative artificial intelligence (GenAI) algorithms implementing multiple agents to represent multiple sides in the process (communication analysis, market analysis, collection, owners, debtors and negotiations strategies) and thereby optimize the debt collection process.

Advantageously, disclosed systems, methods and computer program products improve on the current situation, which is problematic and painful both for the landlords and for the past tenants: the landlord currently loses rent money and needs to spend time recovering the delinquent rent through phone calls, emails, letters, etc. When the landlord fails, he generally submits the case to a 3^{rd} party debt collection agency. Unfortunately, 3^{rd} party collection agencies have a low success rate with collecting the debt. If the 3^{rd} party debt collection agency manages to collect a debt from the past tenant, its handling fee can reach up to 50% of the collected amount. Eventually, the landlord remains with less than 10% of the debt because of the low success rate and high handling fee applied by the collection agency. On the other side, the debtor (the past tenant) going through this procedure may lose his currently rented home and suffer a bad reputation from the legal actions that the 3^{rd} party enforces, such as registration of debt indication on his past debtor's credit report. The procedure may also involve a reduction in their credit score. Moreover, it is common that eviction indications are noted on the debtor records for five years. Another problem for the debtor is the payment of handling fees and interest rates added to the debt. In some cases, and over time, these fees double the debtor's debt.

Advantageously, disclosed systems, methods and computer program products improve communication and optimize conflict resolution with respect to debt collection, to increase the owners' revenues, reduce conflicts and prosecution of debtors, and adjust the negotiation and communication processes to specific debtors and their responses, in a way that is not possible manually. Moreover, embodiments implementing generative artificial intelligence (GenAI) algorithms continuously improve the operation of disclosed systems, methods and computer program products, and thereby yield continuous improvement in their operation and efficiency.

As noted, Landlords, for example, in the US, handle many apartments and, respectfully, tenants. It is not uncommon for a single landlord to simultaneously manage hundreds of apartments and tenants. Property Landlord firms sometimes handle thousands of apartments. Handling so many debt collection matters is very complicated. Embodiments of the present invention provide a landlord system for automatically settling and collecting tenants' debts, which increases the chance of recovering more of the landlord's expenses over time and bridge between the landlord and the past tenants to settle the past tenant's debt. Embodiments of the present invention further enable past tenants to settle their debt and avoid legal actions affecting their credit record and the chance for successfully applying for future apartment rent. Furthermore, embodiments of the present invention prevent payment of collection fees and other debt collection fees applied by debt collection agencies.

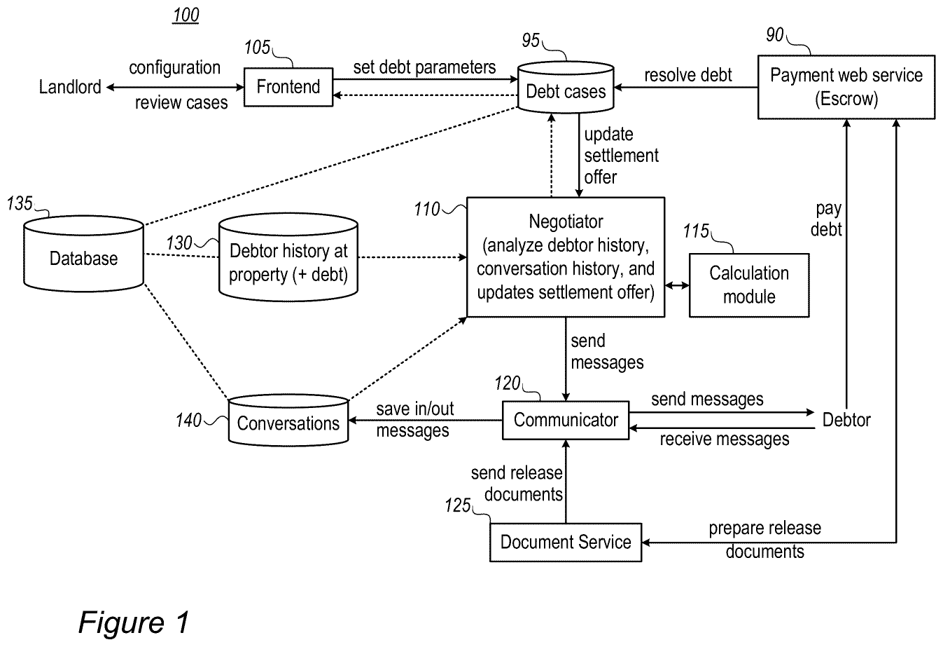

FIG. 1 is a high-level schematic block diagram of a system 100 for settling the debtor's debt in a property management setting, according to some embodiments of the invention. System 100 may be designed for use by the landlord with many units and is intended to facilitate a settlement between the landlord and the debtor (past tenant) before the case reaches a 3^{rd} party collection agency. System 100 includes a database 135 of information related to the debtor, including their debt amount and any relevant legal information. System 100 also includes a communication platform 120 configured to reach out to the debtor and negotiate a settlement.

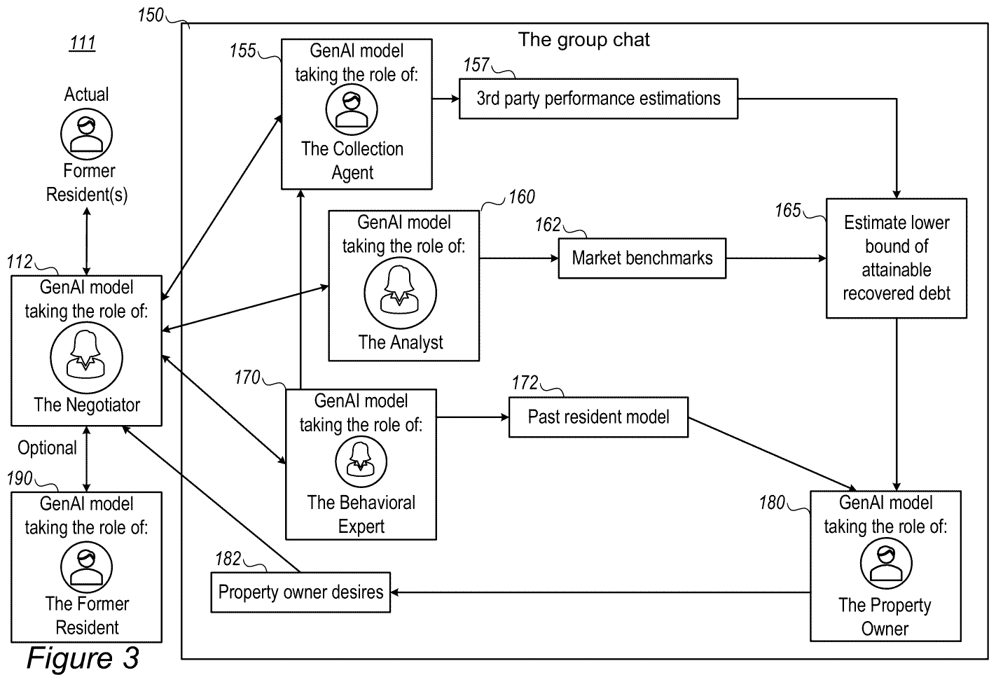

Once a tenant moves out of an apartment with an outstanding debt, system 100 automatically contacts the tenant and reminds them to pay the remainder of their debt. If the tenant cannot pay the full amount, system 100 may automatically negotiate (e.g., via a negotiator 110, and see also FIG. 3) a partial amount of the debt it believes the tenant would agree to pay in exchange for the landlord dropping the legal actions. In some cases, system 100 may propose to the debtor to pay their agreed debt in installments. When an agreement is reached, system 100 documents it and vouches for it (e.g., makes sure the funds would get to the manager if and only if the debtor's debt is cleared), providing a mutually beneficial solution for both the past tenant and the landlord.

System 100 may be designed to be used in the 90-day period before the case reaches a debt collection agency, allowing for a resolution without the need for expensive and time-consuming legal proceedings. By offering an acceptable settlement to both parties, the system reduces the risk of collection fees and legal fees and allows a quicker resolution to the debt issue.

System 100 may be effective in facilitating settlements between landlords and debtors, resulting in a more efficient and cost-effective resolution to debtor debt issues. System 100 may significantly benefit landlords having a large number of units and improve the overall efficiency of the property management process.

System 100 may comprise several modules that work together to facilitate a settlement between the landlord and the debtor. Database module 135 may include or be associated with tenant history database 130, which includes information collected by the property manager's system on the tenant while they were living at the property, including payment history, debt amount, legal information, and communication. System 100 may use this information to determine the appropriate settlement amount. The information is accessible using API to the property management software. A conversations module 140 may store the conversations with the debtor during the settlement negotiations, and be used to train machine learning (ML) or artificial intelligence (AI) algorithms that improve the negotiation and communication over time (see, e.g., FIG. 3). Database module 135 may further comprise a database module of debt cases 95, which tracks the progress of the negotiation process, including the current settlement proposal. Database module 135 may also store the property manager's flexibility limits for the debt and marks its status when resolved.

Communicator module 120 may be configured to timely initiate contact with the debtor. The communication platform sends emails, text messages or makes phone calls to the debtor, depending on the preferences of the landlord and the debtor. The communicator also sends a payment link and a link to a “release document,” which is a statement by the landlord that the debtor no longer has any debt and that the manager ceases any further legal actions. Communicator module 120 may send outbound messages immediately or schedule them to be sent at a predetermined time. Communicator module 120 may be enhanced by generative AI modules to improve the efficiency of the communications towards a higher debt collection rate, e.g., by adjusting the timing, tone and content of the communications based on ML/AI algorithms applied to the accumulating data in Database module 135, possibly emulating the various sides of the communications in multiple AI modules that continuously improve interaction with the debtors, as illustrated schematically in FIG. 3.

Negotiator module 110 may be configured to use the information in database 135 to determine an appropriate settlement amount likely to be accepted by the debtor. The settlement calculation may take into account the following parameters:
(a) The debt amount.
(b) Time since the debtor moved out of the apartment.
(c) Time since the last interaction with the debtor about the debt.
(d) The debtor's credit score (when applicable).
(e) The debtor's payment history at the property (the ledger).
(f) The flexibility of the landlord (an external parameter).
(g) The cost of the debt collection action (an external parameter).
(h) The probability of the debt collection action succeeding. This parameter can be collected and updated based on other landlord's performance.
(i) The text of the conversation made with the debtor so far.

For example, given the above parameters, each day, a calculation module 115 associated with negotiator module 110 may be configured to decide:
a. Whether to communicate with the debtor that day.
b. An acceptable amount to settle on (updated settlement offer).
c. The text of the message that will be sent to the debtor.

A non-limiting example for the way calculation module 115 makes its decisions is provided below:
Let X be the total amount owed by the debtor.
Let f be the manager's flexibility, defined as the minimum fraction of the debt the manager is willing to accept (i.e., f*X is the minimum debt amount the manager is willing to settle for).
Let M be the cost of the debt collection process in dollars.
Hence initial lower limit to collect is L=max(M, f*X).
If the debtor at some point agrees to pay Y, and Y>L, then immediately, L is set to be Y.
Let r=rent/debt. As r is higher, a larger discount is provided by the calculation module.
Let t=weeks passed since the debtor moved out. As t is closer to 0, the calculation module provides a smaller discount.

For example, the formula for the discount may take into account all the mentioned parameters, and the calculation may be performed in a way that maximizes the total discount and the chance that the debtor will pay the proposed debt after the discount. For each Landlord, the variables will have different values.

Once negotiator module 110 decides on the next message to the debtor, the message may be conveyed to communicator module 120, which delivers it to the debtor at a designated time. If the debtor replies to communicator module 120, communicator module 120 converses with the debtor using logic or an AI module based on the data and the logic. Further examples for the configuration and operation of negotiator module 110 as a multi-module Generative AI model, designed to optimize negotiations with past residents for debt resolution—are provided in FIG. 3 described below.

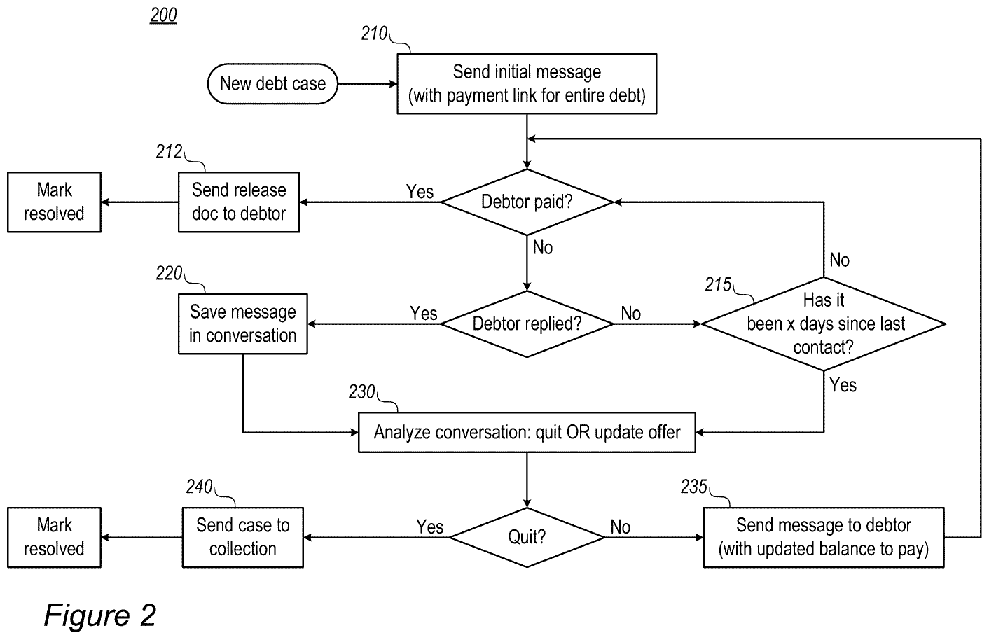

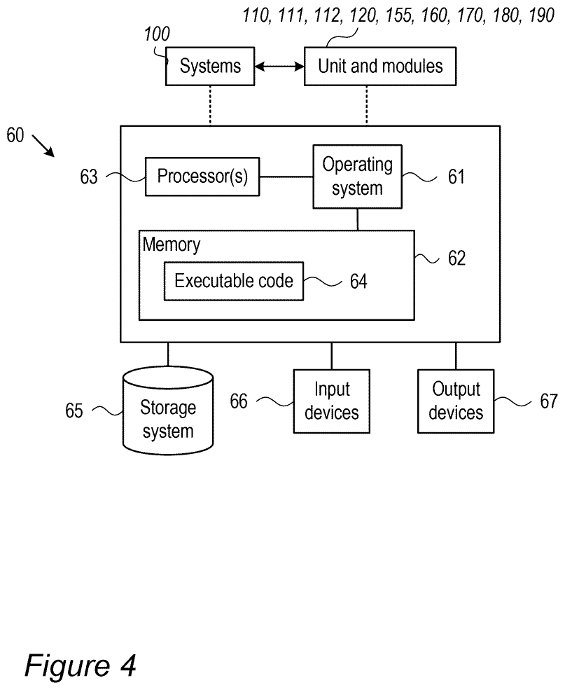

FIG. 2 is a high-level schematic flowchart of a method 200 which may be implemented by system 100—for settling the debtor's debt in a property management setting, according to some embodiments of the invention. The method stages may be carried out with respect to system 100 described herein, which may optionally be configured to implement method 200. Method 200 may be at least partially implemented by at least one computer processor, e.g., in controller(s) 60 disclosed in FIG. 4 or in the disclosed modules. Certain embodiments comprise computer program products comprising a computer readable storage medium having computer readable program embodied therewith and configured to carry out the relevant stages of method 200. Method 200 may comprise the following stages, irrespective of their order.

Upon receiving a new debt case, method 200 may comprise sending an initial message with a payment link for the entire debt (step 210), and if the debtor pays it, sending the release document to the debtor (step 212) and marking the case resolved. If the debtor does not pay the debt and does not reply to the message, method 200 may comprise checking specific criteria for continuing the correspondence (step 215) such as “has it been x days since the last contact from the debtor?”—which determines whether method 200 further awaits payment, or advances in the attempts to reach debt settlement. If the debtor does not pay the debt but does reply to the initial message, further message(s) may be sent (step 220), as explained herein concerning conversations 140 and communicator 120.

Following analysis of the conversation (step 230), method 200 may comprise deciding if to quit the attempts to collect the debt and send the case on to collections by a 3^{rd} party (step 240), resolving the case, or to update the offer for debt settlement, and sending additional message(s) to the debtor, e.g., with an updated balance to pay (step 235)—and repeating the cycle described above, which followed the initial message. Analysis of the conversation and determination whether to quit or to update the offer may be carried out, e.g., by negotiator 110 described herein.

Returning to FIG. 1, system 100 may further comprise a Document Service module 125, which is responsible for generating the legally binding release document that informs “to whom it may concern . . . ” that the debtor no longer has any debt toward the landlord and faces no further legal actions. The document may be generated from a template the landlord can customize to include any other information or legal requirements.

System 100 may further be associated with a Payment Web Service 90, e.g., by a 3^{rd} party, which lets the user pay the agreed amount and transfer the paid amount to an escrow account. Once the payment has been accepted, Payment web service 90 may send a message to document service 125 that triggers the creation of a release document.

System 100 may further comprise a Front-end module 105 responsible for providing the user interface for system 100, allowing a landlord to interact with system 100 and manage the settlement process. Front-end module 105 may be designed to be user-friendly and intuitive, providing landlords with a straightforward and easy-to-use interface. Front-end module 105 may include several features and tools that enable a landlord to manage the settlement process effectively and efficiently. For example, front-end module 105 may include a dashboard that provides an overview of the settlement status, including the total debt amount, the settlement amount, and the payment schedule. Front-end module 105 may also include tools for initiating contact with the debtor, negotiating the settlement amount, and monitoring the progress of the settlement.

Disclosed system modules may be configured to work together to create a seamless and efficient process for settling debtor debt in a property management setting. System 100 may be designed to be user-friendly and to provide landlords with a cost-effective and efficient solution to debtor debt issues.

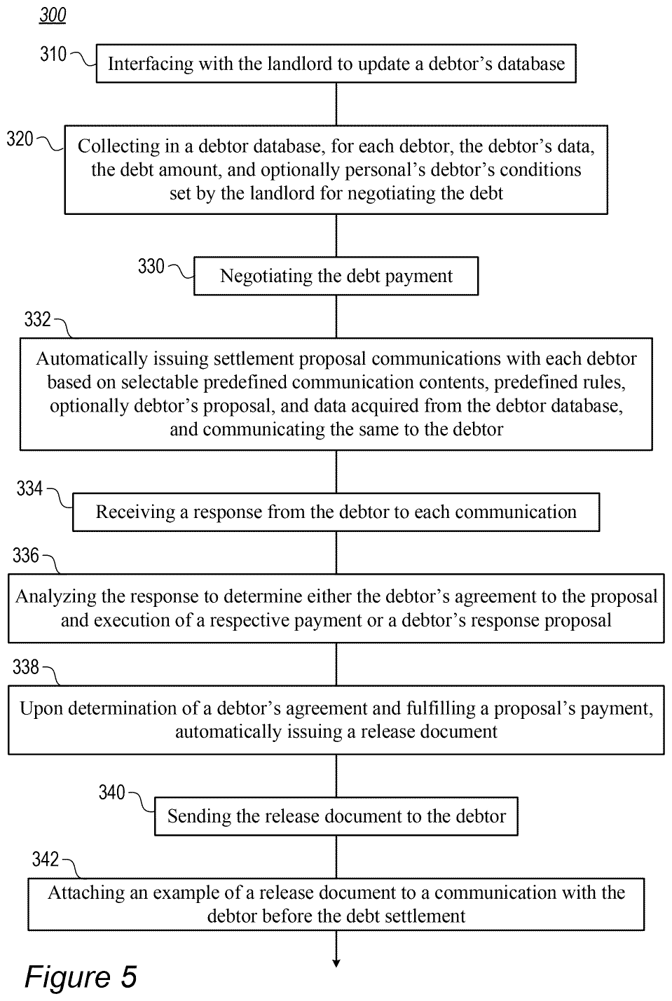

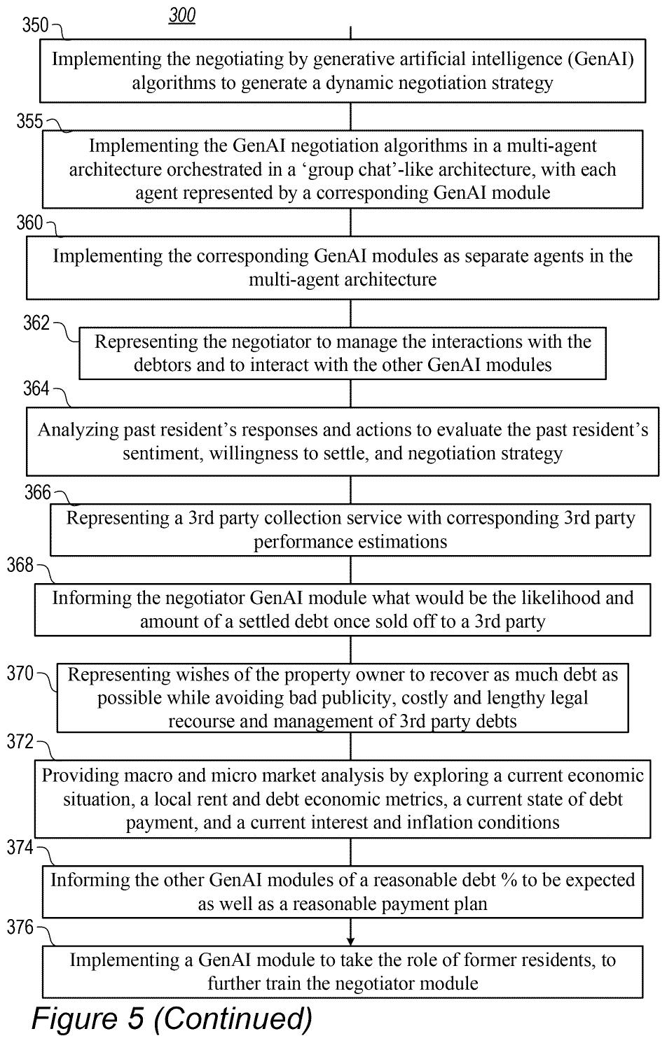

Disclosed Past Tenant Debt-Settlement system 100 provides a novel and non-obvious solution to a longstanding problem in the property management industry. System 100 uses a combination of database module 135, communication module 120 and calculation module 115 that facilitate a settlement between the landlord and the debtor, e.g., via negotiator module 110. System 100 includes several features and modules not found in existing solutions. For example, system 100 may comprise a vouching agreement module (associating payment service 90 and document service 125) acts as a neutral third-party witness to the settlement agreement, providing legal protection for landlords and debtors. Overall, system 100 for settling debtor debt in a property management setting represents a significant advancement in the field in providing a novel and effective solution to a longstanding problem and includes several unique and innovative features not found in existing systems. It is noted that system 100 achieves operationally much more than merely computerizing a manual method, as the huge amount of data and the personalized negotiation with each debtor cannot be practiced manually by landlords or management companies that handle more than a few assets, and certainly not by companies handling hundreds or thousands of assets, typically owned by different landlords with different preferences concerning the debt collection process. Moreover, using ML/AI algorithms described herein, system 100 also improves gradually with respect to its negotiation, communication and settlement capabilities (see, e.g., FIG. 5 below), improving both the operation efficiency of system 100 in future negotiations, communications and settlements, as well as improving the process as a whole—streamlining the debt collection process to the benefit of both landlords and debtors.

FIG. 3 is a high-level schematic illustration of a generative AI negotiator model 111 designed to optimize negotiations with past residents for debt resolution, which may be implemented as part of negotiator module 110, according to some embodiments of the invention. Generative AI negotiator 111 may leverage advanced generative algorithms for dynamic negotiation strategy generation. Initial data input involves a comprehensive analysis of historical communication records, residents' financial behaviors, and contextual variables. This information provides the foundation for generating negotiation plans tailored to the nuanced circumstances of each resident.

A key feature of generative AI negotiator model 111 is its adaptive negotiation tactics. Through extensive simulations, generative AI negotiator model 111 considers residents' financial status, historical payment behaviors, and responses to various communication approaches—e.g., as stored an updated in database 135 and its component databases of debt cases and history and past conversations. This adaptive methodology ensures personalized negotiation strategies aligned with each resident's unique situation, diverging from traditional static approaches. Generative AI negotiator model 111 may implement sentiment analysis enabling the assessment of residents' emotional states based on past interactions and social media data. This empathetic layer enhances communication strategies, increasing the probability of positive responses during negotiations.

The negotiation process involves the generation of optimal payment plans and debt prices. Generative AI negotiator model 111 may evaluate residents' financial capacities, market trends, and historical payment patterns to propose realistic and equitable payment plans. Generative AI negotiator model 111 may also suggest debt prices that strike a balance between maximizing recovery and considering residents' financial constraints.

Generative AI (GenAI) negotiator model 111 may comprise a multi-agent architecture orchestrated in a ‘group chat’ like architecture 150, illustrated schematically and in a non-limiting manner in FIG. 3. For example, multiple GenAI models may be configured to take the roles of the following agents, yielding a multi-model architecture that uses group chat 150 to reach the optimal negotiation results with the former residents. The following model agents may be used, each implemented by respective GenAI modules.

A negotiator GenAI module 112 may be in charge of all agent's input orchestration and all debtor interactions. Negotiator GenAI module 112 may initiate and reply to all user interactions, denoted as the actual former resident(s). Negotiator GenAI module 112 may trigger each agent's operation in group chat 150.

A behavioral expert GenAI module 170 may be in charge of analyzing the past resident's responses and actions to evaluate the past resident's sentiment, willingness to settle, and negotiation strategy (for example-positive, or negative). The results of the analysis are denoted as a past resident model 172.

A collection agent module GenAI 155 may be configured to represent a 3rd party collection service with corresponding 3^{rd} party performance estimations 157. Collection agent GenAI module 155 may inform negotiator GenAI module 112 what would be the likelihood and amount of a settled debt once sold off to a 3rd party.

A property owner GenAI module 180 may be configured to represent the wishes of the property owner (denoted by numeral 182) to recover as much debt as possible while avoiding bad publicity, costly and lengthy legal recourse, management of 3rd party debts, etc.

An analyst GenAI module 160 may be in charge of macro and micro market analysis. Analyst GenAI module 160 may be configured to explore the current economic situation, the local rent and debt economic metrics, the current state of debt payment, and the current interest and inflation conditions (denoted as marker benchmarks 162), and informs the agents of a reasonable debt % to be expected as well as a reasonable payment plan. For example, analyst GenAI module 160 may be configured to derive for each debtor, or groups of debtors, an estimate of the lower bound of attainable recovered debt 165, that may be used as lower threshold for settlements offers presented to the respective debtor(s).

The interaction of the multiple different agents, each being modeled separately by a distinct GenAI module, may be configured to represent real-world interactions, and so improve the operation of negotiation model 111 of negotiator 110 as part of system 100. In certain embodiments, an additional GenAI model 190 may be used to take the role of former residents, to further train negotiator GenAI module 112.

FIG. 4 is a high-level block diagram of exemplary controllers 60, which may be used with embodiments of the present invention. Any of systems 100, units or modules thereof (e.g., in any of modules 110, 111, 112, 120, 155, 160, 170, 180, 190) as well as any of stages of methods 200, 300 (see below) may be implemented using controllers 60 or parts thereof such as processor(s). Controller(s) 60 may include one or more controller or processor 63 that may be or include, for example, one or more central processing unit processor(s) (CPU), one or more Graphics Processing Unit(s) (GPU or general-purpose GPU—GPGPU), a field-programmable gate array (FPGA), an application-specific integrated circuit (ASIC), a digital signal processor (DSP), a microprocessor, a chip, a microchip, an integrated circuit (IC), or any other suitable multi-purpose or specific processor, controller or computational device, an operating system 61, a memory 62, a storage 65, input devices 66 and output devices 67.

Operating system 61 may be or may include any code segment designed and/or configured to perform tasks involving coordination, scheduling, arbitration, supervising, controlling, or otherwise managing operation of controller(s) 60, for example, scheduling execution of programs. Memory 62 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory 62 may be or may include a plurality of possibly different memory units. Memory 62 may store for example, instructions to carry out a method (e.g., code 64), and/or data such as user responses, interruptions, etc.

Executable code 64 may be any executable code, e.g., an application, a program, a process, task or script. Executable code 64 may be executed by controller 63 possibly under control of operating system 61. For example, executable code 64 may when executed cause the production or compilation of computer code, or application execution such as VR execution or inference, according to embodiments of the present invention. Executable code 64 may be code produced by methods described herein. For the various modules and functions described herein, one or more computing devices and/or components of controller(s) 60 may be used. Devices that include components similar or different to those included in controller(s) 60 may be used and may be connected to a network and used as a system. One or more processor(s) 63 may be configured to carry out embodiments of the present invention by for example executing software or code.

Storage 65 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, VR model data, parameters, etc. may be stored in a storage 65 and may be loaded from storage 65 into a memory 62 where it may be processed by controller 63. In some embodiments, some of the components shown in FIG. 4 may be omitted.

Input devices 66 may be or may include for example a mouse, a keyboard, a touch screen or pad or any suitable input device. It will be recognized that any suitable number of input devices may be operatively connected to controller(s) 60 as shown by block 66. Output devices 67 may include one or more displays, speakers and/or any other suitable output devices. It will be recognized that any suitable number of output devices may be operatively connected to controller(s) 60 as shown by block 67. Any applicable input/output (I/O) devices may be connected to controller(s) 60, for example, a wired or wireless network interface card (NIC), a modem, printer or facsimile machine, a universal serial bus (USB) device or external hard drive may be included in input devices 66 and/or output devices 67.

Embodiments of the invention may include one or more article(s) (e.g., memory 62 or storage 65) such as a computer or processor non-transitory readable medium, or a computer or processor non-transitory storage medium, such as for example a memory as disclosed herein, a disk drive, or a USB flash memory, encoding, including or storing instructions, e.g., computer-executable instructions, which, when executed by a processor or controller, carry out methods disclosed herein.

FIG. 5 is a high-level schematic flowchart of a computerized method 300 which may implement method 200 and/or be implemented by system 100—for settling the debtor's debt in a property management setting, according to some embodiments of the invention. The method stages may be carried out with respect to system 100 described herein, which may optionally be configured to implement method 300. Method 300 may be at least partially implemented by at least one computer processor, e.g., in controller(s) 60 disclosed in FIG. 4 or in the disclosed modules. Certain embodiments comprise computer program products (e.g., as described below) comprising a computer readable storage medium having computer readable program embodied therewith and configured to carry out the relevant stages of method 300. Method 300 may comprise the following stages, irrespective of their order.

Computer-implemented automatic landlord method 300 of settling debtors' debts following termination or end of a property contract, may comprise interfacing with the landlord to update a debtor's database (step 310), collecting in a debtor database, for each debtor, the debtor's data, the debt amount, and optionally personal's debtor's conditions set by the landlord for negotiating the debt (step 320), and negotiating the debt payment (step 330), by: automatically issuing one or more settlement proposal communications with each debtor based on selectable predefined communication contents, predefined rules, optionally debtor's proposal, and data acquired from said debtor database, and communicating the same to the debtor (step 332), receiving a response from the debtor to each communication (step 334), analyzing the received response to determine either the debtor's agreement to the proposal and execution of a respective payment or a debtor's response proposal (step 336), upon determination of a debtor's agreement and fulfilling a proposal's payment, automatically issuing a release document (step 338), and sending the release document to the debtor (step 340).

In certain embodiments, the debtor's data includes the debtor's personal data, the type of communication preference, and debtor's communication address, and in addition, one or more of: time since the debtor moved out, time since a last interaction with the debtor about the debt, debtor's credit score, debtor's payment history at the property, negotiation flexibility of the landlord, cost of a debt collection action, probability of succeeding in a debt collection action, and previous text conversations made with the debtor. In various embodiments, the debtor's communication is selectable from an email, messaging, or calls.

In certain embodiments, the release document may include an irrevocable landlord's obligation that the debtor has fully settled his debt and will not face any further legal action. In certain embodiments, method 300 may further comprise attaching an example of a release document to a communication with the debtor before the debt settlement (step 342).

In various embodiments, the computer-implemented method may further comprise implementing the negotiating by generative artificial intelligence (GenAI) algorithms to generate a dynamic negotiation strategy (step 350), for example, the computer-implemented method may comprise implementing the GenAI negotiation algorithms in a multi-agent architecture orchestrated in a ‘group chat’-like architecture, with each agent represented by a corresponding GenAI module (step 355). In certain embodiments, method 300 may comprise implementing the corresponding GenAI modules as separate agents in the multi-agent architecture (step 360), comprising: (i) representing the negotiator to manage the interactions with the debtors and to interact with the other GenAI modules (step 362), (ii) analyzing past resident's responses and actions to evaluate the past resident's sentiment, willingness to settle, and negotiation strategy (step 364), representing a 3rd party collection service with corresponding 3rd party performance estimations (step 366), informing the negotiator GenAI module what would be the likelihood and amount of a settled debt once sold off to a 3rd party (step 368), representing wishes of the property owner to recover as much debt as possible while avoiding bad publicity, costly and lengthy legal recourse and management of 3rd party debts (step 370), and providing macro and micro market analysis by exploring a current economic situation, a local rent and debt economic metrics, a current state of debt payment, and a current interest and inflation conditions (step 372); and further informing (by the analyst GenAI module) the other GenAI modules of a reasonable debt % to be expected as well as a reasonable payment plan (step 374). In certain embodiments, method 300 may further comprise implementing an additional GenAI module as part of the multi-agent architecture to take the role of former residents, to further train the negotiator GenAI module by implementing the former residents' agent (step 376).

Certain embodiments comprise a computer program product for settling debtors' debts automatic to a landlord system following termination or end of a property contract, the computer program product comprising a non-transitory computer readable storage medium having computer readable program embodied therewith. The computer readable program comprises computer readable program configured to interface with the landlord to update a debtor's database, computer readable program configured to collect in a debtor database, for each debtor, the debtor's data, the debt amount, and optionally personal's debtor's conditions set by the landlord for negotiating the debt, and computer readable program configured to negotiate the debt payment.

The negotiation computer readable program may comprise computer readable program configured to automatically issue one or more settlement proposal communications with each debtor based on selectable predefined communication contents, predefined rules, optionally debtor's proposal, and data acquired from said debtor database, and communicating the same to the debtor, computer readable program configured to receive a response from the debtor to each communication, computer readable program configured to analyze the received response to determine either the debtor's agreement to the proposal and execution of a respective payment or a debtor's response proposal, computer readable program configured to, upon determination of a debtor's agreement and fulfilling a proposal's payment, automatically issue a release document, and computer readable program configured to send the release document to the debtor.

In certain embodiments, the computer readable program may further comprise computer readable program configured to implement the negotiating by generative artificial intelligence (GenAI) algorithms to generate a dynamic negotiation strategy. For example, the computer readable program may comprise computer readable program configured to implement the GenAI negotiation algorithms in a multi-agent architecture orchestrated in a ‘group chat’-like architecture, with each agent represented by a corresponding GenAI module.

The computer readable program may further comprise computer readable program configured to implement the corresponding GenAI modules as separate agents in the multi-agent architecture, including, for example, any of: computer readable program configured to represent the negotiator to manage the interactions with the debtors and to interact with the other GenAI modules, computer readable program configured to analyze past resident's responses and actions to evaluate the past resident's sentiment, willingness to settle, and negotiation strategy, computer readable program configured to represent a 3rd party collection service with corresponding 3rd party performance estimations and to inform the negotiator GenAI module what would be the likelihood and amount of a settled debt once sold off to a 3rd party, computer readable program configured to represent wishes of the property owner to recover as much debt as possible while avoiding bad publicity, costly and lengthy legal recourse and management of 3rd party debts, and computer readable program configured to provide macro and micro market analysis by exploring a current economic situation, a local rent and debt economic metrics, a current state of debt payment, and a current interest and inflation conditions, wherein the analyst GenAI module further informs the other GenAI modules of a reasonable debt % to be expected as well as a reasonable payment plan. The computer readable program may further comprise computer readable program configured to implement an additional GenAI module as part of the multi-agent architecture to take the role of former residents, to further train the negotiator GenAI module by implementing the former residents' agent.

Elements from FIGS. 1-5 may be combined in any operable combination, and the illustration of certain elements in certain figures and not in others merely serves an explanatory purpose and is non-limiting.

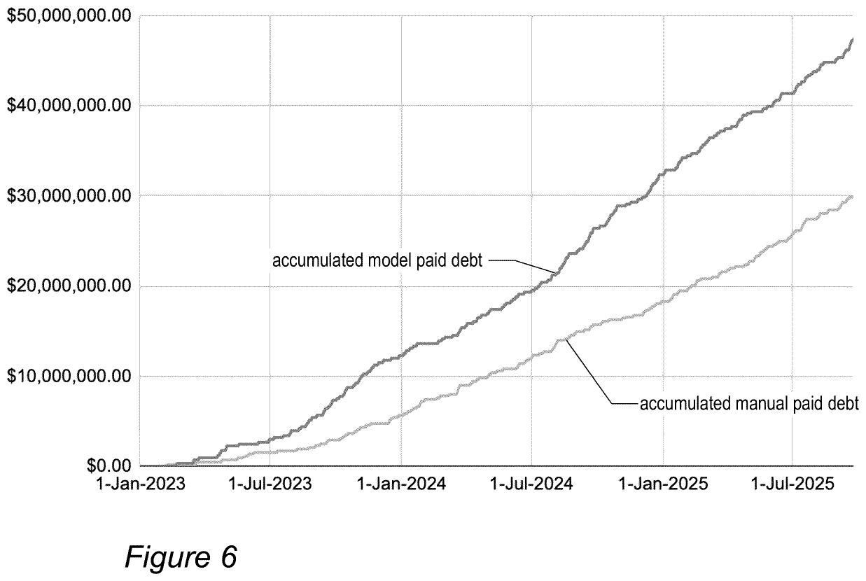

FIG. 6 provides experimental results indicating the long-term improvement achieved by disclosed systems 100 and methods 200, 300 in collecting the debt, according to some embodiments of the invention. The data representing the manually collected debt is based on the average result of several communities for a specific property owner. The data representing the automated debt collection service are for rental units of the same property owner, to which the automated debt collection service was applied. The gradual improvement is shown as a comparison of the accumulated model paid debt with accumulated manual paid debt over thirty months, indicating an almost 50% improvement of debt collection by disclosed systems 100 and methods 200, 300 over manual collection, resulting not only in increased profit to the landlords, but also in streamlining the debt collection process with respect to the communication and negotiations with the debtors, to the mutual benefit of both landlords and debtors.

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram or portions thereof.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram or portions thereof.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. An automatic landlord system for settling debtors' debts following termination or end of a property contract, the system comprising, at the landlord side:
a landlord interface for updating a debtor's database,
a debtor database comprising, for each debtor, the debtor's data, the debt amount, and optionally personal's debtor's conditions set by the landlord for negotiating the debt, and
a negotiator for:
automatically issuing one or more settlement proposal communications with each debtor based on selectable predefined communication contents, predefined rules, optionally debtor's proposal, and data acquired from said debtor database, and communicating the same to the debtor,
receiving a response from the debtor to each communication,
analyzing the received response to determine either the debtor's agreement to the proposal and execution of a respective payment or a debtor's response proposal,
upon determination of a debtor's agreement and fulfilling a proposal's payment, automatically issuing a release document, and
sending the release document to the debtor.

2. The system of claim 1, wherein the debtor's data includes the debtor's personal data, the type of communication preference, and debtor's communication address, and in addition, one or more of:
(a) time since the debtor moved out,
(b) time since a last interaction with the debtor about the debt,
(c) debtor's credit score,
(d) debtor's payment history at the property,
(e) negotiation flexibility of the landlord,
(f) cost of a debt collection action,
(g) probability of succeeding in a debt collection action, and
(h) previous text conversations made with the debtor.

3. The system of claim 1, wherein the debtor's communication is selectable from an email, messaging, or calls.

4. The system of claim 1, wherein said release document includes an irrevocable landlord's obligation that the debtor has fully settled his debt and will not face any further legal action.

5. The system of claim 4, wherein an example of a release document is attached to a communication with the debtor before the debt settlement.

6. The system of claim 1, wherein the negotiator is implemented generative artificial intelligence (GenAI) algorithms to generate a dynamic negotiation strategy.

7. The system of claim 6, wherein the GenAI negotiation algorithms implement a multi-agent architecture orchestrated in a ‘group chat’-like architecture, with each agent represented by a corresponding GenAI module.

8. The system of claim 7, wherein the GenAI modules comprise:
a negotiator GenAI module to represent the negotiator to manage the interactions with the debtors and to interact with the other GenAI modules,
a behavioral expert GenAI module to analyze past resident's responses and actions to evaluate the past resident's sentiment, willingness to settle, and negotiation strategy,
a collection agent module GenAI to represent a 3rd party collection service with corresponding 3rd party performance estimations and to inform the negotiator GenAI module what would be the likelihood and amount of a settled debt once sold off to a 3rd party,
a property owner GenAI module to represent wishes of the property owner to recover as much debt as possible while avoiding bad publicity, costly and lengthy legal recourse and management of 3rd party debts, and
an analyst GenAI module to provide macro and micro market analysis by exploring a current economic situation, a local rent and debt economic metrics, a current state of debt payment, and a current interest and inflation conditions, wherein the analyst GenAI module further informs the other GenAI modules of a reasonable debt % to be expected as well as a reasonable payment plan.

9. A computer-implemented automatic landlord method of settling debtors' debts following termination or end of a property contract, the method comprising:
interfacing with the landlord to update a debtor's database,
collecting in a debtor database, for each debtor, the debtor's data, the debt amount, and optionally personal's debtor's conditions set by the landlord for negotiating the debt, and
negotiating the debt payment by:
automatically issuing one or more settlement proposal communications with each debtor based on selectable predefined communication contents, predefined rules, optionally debtor's proposal, and data acquired from said debtor database, and communicating the same to the debtor,
receiving a response from the debtor to each communication,
analyzing the received response to determine either the debtor's agreement to the proposal and execution of a respective payment or a debtor's response proposal,
upon determination of a debtor's agreement and fulfilling a proposal's payment, automatically issuing a release document, and
sending the release document to the debtor.

10. The computer-implemented method of claim 9, wherein the debtor's data includes the debtor's personal data, the type of communication preference, and debtor's communication address, and in addition, one or more of:
(i) time since the debtor moved out;
(j) time since a last interaction with the debtor about the debt;
(k) debtor's credit score;
(l) debtor's payment history at the property;
(m) negotiation flexibility of the landlord;
(n) cost of a debt collection action;
(o) probability of succeeding in a debt collection action; and
(p) previous text conversations made with the debtor.

11. The computer-implemented method of claim 9, wherein the debtor's communication is selectable from an email, messaging, or calls.

12. The computer-implemented method of claim 9, wherein said release document, includes an irrevocable landlord's obligation that the debtor has fully settled his debt and will not face any further legal action.

13. The computer-implemented method of claim 12, further comprising attaching an example of a release document to a communication with the debtor before the debt settlement.

14. The computer-implemented method of claim 9, further comprising implementing the negotiating by generative artificial intelligence (GenAI) algorithms to generate a dynamic negotiation strategy.

15. The computer-implemented method of claim 14, further comprising implementing the GenAI negotiation algorithms in a multi-agent architecture orchestrated in a ‘group chat’-like architecture, with each agent represented by a corresponding GenAI module.

16. The computer-implemented method of claim 15, further comprising implementing the corresponding GenAI modules as separate agents in the multi-agent architecture:
to represent the negotiator to manage the interactions with the debtors and to interact with the other GenAI modules,
to analyze past resident's responses and actions to evaluate the past resident's sentiment, willingness to settle, and negotiation strategy,
to represent a 3rd party collection service with corresponding 3rd party performance estimations and to inform the negotiator GenAI module what would be the likelihood and amount of a settled debt once sold off to a 3rd party,
to represent wishes of the property owner to recover as much debt as possible while avoiding bad publicity, costly and lengthy legal recourse and management of 3rd party debts, and
to provide macro and micro market analysis by exploring a current economic situation, a local rent and debt economic metrics, a current state of debt payment, and a current interest and inflation conditions, wherein the analyst GenAI module further informs the other GenAI modules of a reasonable debt % to be expected as well as a reasonable payment plan.

17. A computer program product for settling debtors' debts automatic to a landlord system following termination or end of a property contract, the computer program product comprising a non-transitory computer readable storage medium having computer readable program embodied therewith, the computer readable program comprising:
computer readable program configured to interface with the landlord to update a debtor's database,
computer readable program configured to collect in a debtor database, for each debtor, the debtor's data, the debt amount, and optionally personal's debtor's conditions set by the landlord for negotiating the debt, and
computer readable program configured to negotiate the debt payment and comprising:
computer readable program configured to automatically issue one or more settlement proposal communications with each debtor based on selectable predefined communication contents, predefined rules, optionally debtor's proposal, and data acquired from said debtor database, and communicating the same to the debtor,
computer readable program configured to receive a response from the debtor to each communication,
computer readable program configured to analyze the received response to determine either the debtor's agreement to the proposal and execution of a respective payment or a debtor's response proposal,
computer readable program configured to, upon determination of a debtor's agreement and fulfilling a proposal's payment, automatically issue a release document, and
computer readable program configured to send the release document to the debtor.

18. The computer program product of claim 17, wherein the computer readable program further comprises computer readable program configured to implement the negotiating by generative artificial intelligence (GenAI) algorithms to generate a dynamic negotiation strategy.

19. The computer program product of claim 18, wherein the computer readable program further comprises computer readable program configured to implement the GenAI negotiation algorithms in a multi-agent architecture orchestrated in a ‘group chat’-like architecture, with each agent represented by a corresponding GenAI module.

20. The computer program product of claim 18, wherein the computer readable program further comprises computer readable program configured to implement the corresponding GenAI modules as separate agents in the multi-agent architecture, the computer readable program further comprises:
computer readable program configured to represent the negotiator to manage the interactions with the debtors and to interact with the other GenAI modules,
computer readable program configured to analyze past resident's responses and actions to evaluate the past resident's sentiment, willingness to settle, and negotiation strategy,
computer readable program configured to represent a 3rd party collection service with corresponding 3rd party performance estimations and to inform the negotiator GenAI module what would be the likelihood and amount of a settled debt once sold off to a 3rd party,
computer readable program configured to represent wishes of the property owner to recover as much debt as possible while avoiding bad publicity, costly and lengthy legal recourse and management of 3rd party debts, and
computer readable program configured to provide macro and micro market analysis by exploring a current economic situation, a local rent and debt economic metrics, a current state of debt payment, and a current interest and inflation conditions, wherein the analyst GenAI module further informs the other GenAI modules of a reasonable debt % to be expected as well as a reasonable payment plan.
